(19) United States
(12) Patent Application Publication
(10) Pub. No.: US 2018/0202811 A1
(43) Pub. Date: Jul. 19, 2018

(54) NAVIGATION USING AN IMAGE OF A TOPOLOGICAL MAP

(71) Applicant: International Business Machines Corporation, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(21) Appl. No.: 15/705,419

(22) Filed: Sep. 15, 2017

Related U.S. Application Data
(63) Continuation of application No. 15/407,309, filed on Jan. 17, 2017.

(51) Int. Cl. G01C 21/00; H04W 4/02

(52) U.S. Cl. CPC G01C 21/005; H04W 4/023

(57) ABSTRACT

A method, computer program product and computer system is provided. A processor receives an image of a topological map. A processor determines a first feature of the topological map. A processor determines a second feature of the topological map, wherein the first and second features are indicative of a first and second geographical location in a geographical map. A processor determines a first topological distance between the first feature and the second feature. A processor determines a first geographical distance between the first geographical location and the second geographical location. A processor retrieves a current geographical location of a mobile device. A processor determines a topological location of the mobile device on the image of the topological map, wherein the topological location is based, at least in part, on the first topological distance, the first geographical distance, and the current geographical location of the mobile device.

### BACKGROUND OF THE INVENTION

The present invention relates generally to the field of navigation, and more particularly to providing navigation using a captured image of a topological map.

Navigation systems determine a route for a user to take in order to reach a destination. Typically, navigation systems base the route on one or more geographical maps. A geographical map includes a variety of data such as a location of paths for the route (e.g., roads), features of the area (e.g., bodies of water) and other geospatial information (e.g., elevation). A topological map is a type of diagram or visualization of an area. Typically, a topological map has been simplified so that only vital information remains or unnecessary detail has been removed. An example type of topological map is for a transit system, such as a subway. Some topological maps lack scale, where distance and direction are subject to change and variation throughout the map (e.g., the distance varies between stations in a subway map). However, most topological maps maintain a relationship between points of interest (e.g., the names of stations and their interconnections to other stations).

### SUMMARY

Embodiments of the present invention provide a method, system, and program product to provide navigation via a topological map. A processor receives an image of a topological map. A processor determines a first feature of the topological map. A processor determines a second feature of the topological map, wherein the first and second features are indicative of a first and second geographical location in a geographical map. A processor determines a first topological distance between the first feature and the second feature. A processor determines a first geographical distance between the first geographical location and the second geographical location. A processor retrieves a current geographical location of a mobile device. A processor determines a topological location of the mobile device on the image of the topological map, wherein the topological location is based, at least in part, on the first topological distance, the first geographical distance, and the current geographical location of the mobile device.

### BRIEF DESCRIPTION OF THE SEVERAL VIEWS OF THE DRAWINGS

FIG. 1 is a functional block diagram illustrating a networked environment, in accordance with an exemplary embodiment of the present invention.

FIGS. 2A-2B illustrates operational processes of a mapping program, on a mobile device within the environment of FIG. 1, in accordance with an exemplary embodiment of the present invention.

FIG. 3 depicts an example visualization of the feature mapping processes of a mapping program.

FIG. 4 depicts a block diagram of components of the computing device executing a mapping program, in accordance with an exemplary embodiment of the present invention.

### DETAILED DESCRIPTION

Many navigation programs present a geographical map to a user when determining a route to a destination within an area. Geographical maps include the location of various paths (e.g., roads) and features (e.g., buildings) found in a specific area. Typically, a geographical map is displayed with a constant scale (e.g., an inch on a geographical map is equal to a mile traveled for the area). In some instances, a topological map is available for the area. An topological map may change scale for different portions of the map. For example, transit maps for subways sometimes have a fixed distance between stations, but the distance traveled between stations varies. Topological maps present information about an area in an easily digestible format that offers “at-a-glance” information for the area without the need for a user viewing an entire geographical map for said area. Embodiments of the present invention recognize that by providing navigation with the use of topological maps, a more simple and directed navigation experience can be delivered to a user. Furthermore, in some instances where a geographical map or corresponding geospatial data may not exist for an area, such as hiking trails, a topological map may be provided (e.g., a hiking trail map found at a park's welcome center). Embodiments of the present invention recognize that by analyzing and mapping features found in the topological map to the geographical map for the same area, a navigation experience can be integrated with the topological map and navigation program.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

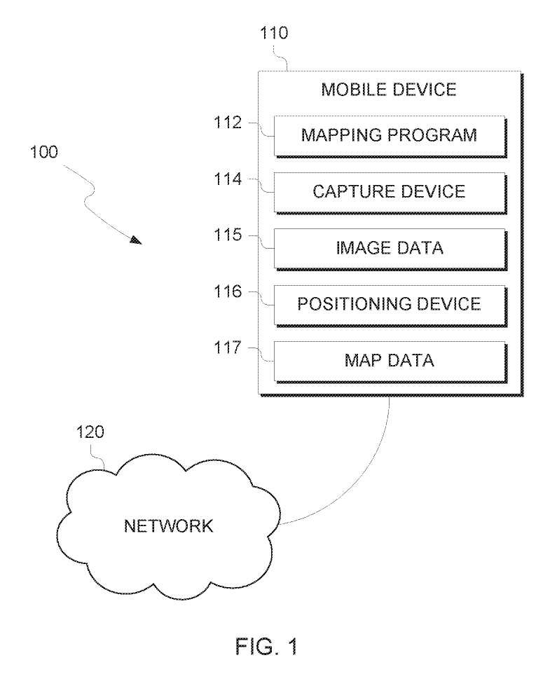

The present invention will now be described in detail with reference to the Figures. FIG. 1 is a functional block diagram illustrating networked environment, generally designated 100, in accordance with one embodiment of the present invention. Networked environment 100 includes mobile device 110 connected over network 120. Mobile device 110 includes mapping program 112, capture device 114, positioning device 116, image data 115 and map data 117.

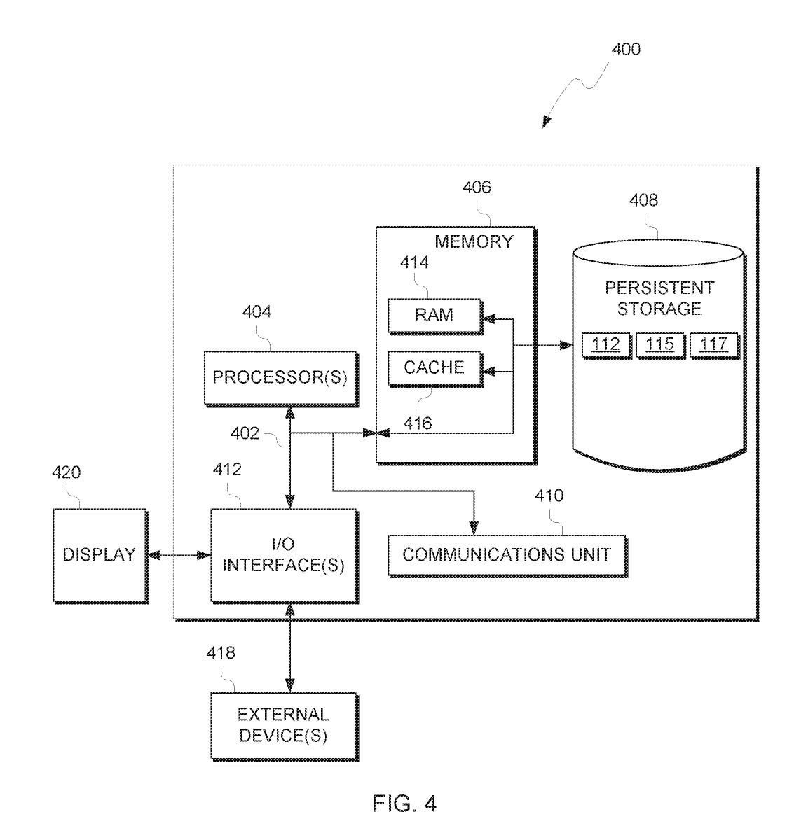

In various embodiments of the present invention, mobile device 110 is a computing device that can be a standalone device, a server, a laptop computer, a tablet computer, a netbook computer, a personal computer (PC), or a desktop computer. In another embodiment, mobile device 110 represents a computing system utilizing clustered computers and components to act as a single pool of seamless resources. In general, mobile device 110 can be any computing device or a combination of devices with access to capture device 114, image data 115, positioning device 116, and map data 117 and is capable of executing mapping program 112. Mobile device 110 may include internal and external hardware components, as depicted and described in further detail with respect to FIG. 4.

In this exemplary embodiment, mapping program 112, image data 115 and map data 117 are stored on mobile device 110 and capture device 114 and positioning device 116 are included components of mobile device 110. However, in other embodiments, mapping program 112, image data 115 and map data 117 may be stored externally and accessed through a communication network, such as network 120. In some embodiments, capture device 114 and positioning device 116 may a component of another computing device (not shown) and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between mobile device 110 and other computing devices (not shown), in accordance with a desired embodiment of the present invention.

In various embodiments, mobile device 110 includes capture device 114. For example, capture device 114 may be a still image camera, a video camera, a scanner, or any other device or component capable of capturing video or images. In various embodiments, mapping program 112 retrieves an image of a topological map. In some embodiments, mapping program 112 retrieves an image from capture device 114. For example, a user captures an image of a transit map while at a subway with mobile device 110. In other embodiments, capture device 114 is a component of another device (not shown). For example, a user scans a topological map and uploads the image to an online repository. In such embodiments, mapping program 112 retrieves the image from the online repository. In further embodiments, capture device 114 is not utilized and a user provides a location of the image to mapping program 112. For example, a user finds a topological map online and saves the file locally or in an online repository. The user provides a location or link to mapping program 112 to retrieve the image.

Upon retrieval of the image of the topological map, mapping program 112 stores the retrieved image in image data 115. Image data 115 includes one or more images of topological maps. A topological map is a map that has been simplified so that relevant information remains and unnecessary detail is removed. For example, a map for a college campus may only list the names and location of buildings associated with the college, but remove the names or even the display of buildings not associated with the college (e.g., off-campus housing).

Other types of topological maps, such as a map for a subway or bus routes, alter the scale or perception of an area to either condense or better present a large amount of information in a smaller space. Typically, these types of topological maps lack a consistent scale for the entirety of the map. One inch on a portion of the map is equal to a different real-world distance than one inch on another portion of the same map. Also, the direction of a path or road may not match the real-world direction of the corresponding path. For example, topological subway maps typically only show routes in increment of 45°. However, the relationship between stations is maintained (e.g., the connecting routes are shown but the direction or distance of the displayed route does not match the real-world subway track). Example topological maps include transit maps (e.g., subway or bus routes), campus maps (e.g., college campuses or business campuses), park maps (theme parks or national parks), or any map that is an altered or abstract representation of a given area.

As such, topological maps provide directed and, typically, more informative views of an area than that of a geographical map. A geographical map is a map of an area that typically conforms to a uniform scale and provides information for the surrounding area with accuracy in mind. Geographical maps are geospatial representations of an area, which typically include as many buildings, landmarks, paths, roads or other features as known. The distance and elevation of features are represented with accuracy in mind. In various embodiments, map data 117 includes one or more electronic maps with geographical map data. In some embodiments, mapping program 112 retrieves map data 117 from a server (not shown). Map data 117 also includes the position, name and location of various features for an area. Features in a geographical map data include, but are not limited to, the names and geographical locations of buildings, parks, stadiums, building complexes, or any other landmark that may be a location in a topological map (e.g., a subway station). A geographical map in map data 117 may also include one or more paths such as roads, walking paths, or public transit lines that connect features of the map.

In various embodiments, mobile device 110 includes positioning device 116 to determine the current location of mobile device 110. As a user moves in a given area, positioning device 116 provides the current location of mobile device 110 to mapping program 112. Mapping program 112 determines the current location in a geographical map stored in map data 117. As discussed herein, mapping program 112 determines a position on the captured image of a topological map in image data 115 that corresponds to the location on the geographical map stored in map data. In some embodiments, positioning device 116 is a Global Positioning System (GPS) receiver. In other embodiments, positioning device 116 includes one or more processors or software to determine the location of mobile device 110 by comparing signal strengths received from one or more transceivers (e.g., cellular towers or wireless routers). In an embodiment, positioning device 116 includes both hardware and software to determine the location of mobile device 110. One of ordinary skill in the art will appreciate that any known hardware components, software techniques, or a combination thereof may be used for determining the location of mobile device 110 without deviating from the scope of the invention.

In various embodiments, mapping program 112 determines one or more features of the topological map stored in image data 115. Mapping program 112 performs optical character recognition (OCR) to the image of the topological map to determine the names or text associated with different features displayed in the map. Mapping program 112 performs pattern recognition to determine the location and relationship between features displayed in the topological map. For example, mapping program 112 determines the locations of different paths in the map (e.g., lines in a subway). Mapping program 112 determines any intersections of the paths and names associated with the intersections (e.g., stations in a subway). In various embodiments, by performing pattern recognition and OCR, mapping program 112 determines the content and relationship of the content displayed by the topological map. In some embodiments, mapping program 112 determines one or more features based on the context of the feature. For example, mapping program 112 determines that text found at the top of the topological map is a title of the map. As another example, mapping program 112 determines that text found in a box on the periphery of the map is a legend. As such, mapping program 112 includes the additional contextual information when determining the features of a topological map (e.g., a line with the same color in the legend is associated with the name used in the legend).

In various embodiments, mapping program 112 determines a mapping of the features of the topological map to locations in the geographical map. Mapping program 112 determines a location on the geographical map corresponding to a feature of the topological map. For example, a bus stop has the name of an apartment complex (e.g., Luxury Lake Apartments). Mapping program 112 determines the name of a bus stop via OCR to be the apartment complex. Mapping program 112 searches map data 117 to find the location of the named apartment complex. Mapping program 112 assigns the location of the feature to the location of the named apartment complex. In some scenarios, mapping program 112 may send a query to a search engine or other database (not shown) for the location of a feature in a topological map. In some embodiments, mapping program 112 determines the location of a feature of a topological map based on the feature's relationship to other features of the topological map. For example, mapping program 112 cannot find a feature of a topological map in map data 117 or any other source. Mapping program 112 compares other features of the topological map to determine the location of the unknown feature. If the unknown feature is located between two known features of a topological map, mapping program 112 assigns the location of the unknown feature to a point in between the known features based on the known features location in the geographical map in map data 117.

In various embodiments, mapping program 112 provides navigation to a user of mobile device 110. Mapping program 112 receives a destination from the user and determines a route to the destination using the topological map in image data 115 to determine a path. In some scenarios, the destination is an area of the topological map. For example, mobile device 110 includes a touch enabled display. When receiving a destination, mapping program 112 displays the captured image of the topological map. Mapping program 112 receives input from a user touching the display and selects a destination corresponding to the area of the topological map the user touched. Furthermore, mapping program 112 receives other input indicating a name or other feature as a destination. For example, the input could be a string of text or a verbal command. Mapping program 112 searches for the content contained in the input among the determined features of the topological map. If a feature matches the input, then mapping program 112 sets the matching feature as the destination.

In some embodiments, mapping program 112 retrieves a start point of user of mobile device 110. In some scenarios, mapping program 112 retrieves the current location of mobile device 110 from positioning device 116, which would be the start point for navigation. In other scenarios, positioning device 116 may not be able to provide a current location. In such scenarios, mapping program 112 may analyze the features of the topological map to determine the current location of the user or mobile device 110. For example, mapping program 112 determines the content of a legend of the topological map includes that a star shape indicates that is the current location of the user (e.g., “You are Here”). Mapping program 112 determines the location of the star in the topological map in relation to other features in the topological map. In some scenarios, mapping program 112 selects the closest intersection of paths for transit maps. For campus maps, mapping program 112 selects the closest structure or feature. In other embodiments, mapping program 112 receives input from the user (e.g., touch input on the topological map or text input) for a starting point.

In various embodiments, mapping program 112 determines a route between the start point and the destination point. Based on the location of the start and destination points, mapping program 112 determines a route to the destination with a geographical map in map data 117. Mapping program 112 identifies the various paths in map data 117 and determines a route between the start and destination locations. For example, mapping program 112 selects a set of paths that reach the destination and create the shortest overall route. In various embodiments, mapping program 112 determines a route using the detected paths in the image of the topological map. For example, a transit map for a subway has paths between stations. Mapping program 112 determines a path between the destination station and the current station mobile device 110 is located. Mapping program 112 highlights the subway line (or path) in an image of the subway map, indicating to the user how to reach the destination station with the paths indicated in the image of the topological map. In an embodiment, mapping program 112 retrieves various geographical paths from another server (not shown). For example, an operator of a bus route or a third party provides the various roads taken by different buses. When determining a route to a destination, mapping program 112 retrieves the provided geographical paths from the operator or third party. In this embodiment, mapping program 112 determines a route based on the retrieved paths from the operator or third party (e.g., a path is determined only using the roads traveled by buses).

In various embodiments, as a user navigates to the destination, mapping program 112 provides directions to the user. For example, if a user needs to make a transfer using a transit system, mapping program 112 provides an indication to make the transfer when they arrive at the appropriate station or bus stop. If a user is in a campus with walking paths, then mapping program 112 provides directions when to take certain paths to reach the destination. In some embodiments, mapping program 112 provides information regarding the current route such as distance to travel until the destination is reached, expected arrival time, and expected duration. When determining an arrival time or remaining duration of the route, mapping program 112 considers the mode of transportation. For example, if the topological map is a hiking trail, mapping program 112 uses an average walking speed (e.g., a few miles per hour) and the distance remaining to determine the arrival time. If the topological map is for a transit system such as a bus route, mapping program 112 retrieves a timetable associated with the bus line to determine the expected arrival time of the bus route needed to reach the destination. Furthermore, mapping program 112 may retrieve traffic data regarding the roads of the geographic map the determined route takes to reach the destination to adjust the arrival time.

In various embodiments, mapping program 112 determines a current position of mobile device 110 both on the geographical map in map data 117 and the image of the topological map in image data 115. As discussed herein, mapping program 112 retrieves a current position of mobile device 110 from positioning device 116 in regards to the geographical map in map data 117. Mapping program 112 compares the current location to the route of the geographical map. Mapping program 112 determines the closest two features of the route on the geographical map identified on the image of the topological map. In some scenarios, the route segment for the geographical routes have various sub-segments not present on the topological map. For example, a topological map for a bus route has two stops “City Park Stop” and “Shopping Mall Stop”. On the topological map, a single route segment connects the two. However, on a geographical map, the bus route includes multiple roads. In such scenarios, mapping program 112 combines the component roads of the geographical map to an equivalent route segment when comparing a segment of the topological map.

In various embodiments, mapping program 112 determines a distance metric for each of the topological route segments and the geographical route segments in a route. Since some topological maps may alter the scale for each segment (e.g., a transit map), the distance metric is determined for each topological map segment to determine a scale or ratio with the corresponding geographical map's segment. In regards to the topological map segment, since the topological map may not have a scale corresponding to the geographical map, another type of distance metric may be used. For example, for a given segment of a route, mapping program 112 determines the distance of the segment in the geographical map. In a scenario, a route segment may not exist in map data 117 (e.g., a subway tunnel), but the beginning and end points of the segment are identified in map data 117 (e.g., two subway stations). In such a scenario, mapping program 112 determines the distance of the segment as a straight line distance between the stations. In another scenario, multiple geographical segments correspond to a single topological segment. As such, mapping program 112 tallies the distance of all geographical segments for the total distance of the segment. Regarding the topological segment, mapping program 112 determines a distance of the segment based on the length the segment covers in the captured image. In some scenarios, the distance of the segment is the number of pixels of the image. In other scenarios, a length may be determined corresponding the real-world map the topological map image was captured from (e.g., millimeters or inches).

In various embodiments, mapping program 112 determines a ratio for the corresponding map segments of the topological and geographical maps. Mapping program 112 uses the ratio to determine the current location of mobile device 110 on the topological map, based on the current location of mobile device on the geographical map. For a given segment, mapping program 112 determines a ratio between the distance travelled in the geographical map and the corresponding distance travelled on the topological map. In some scenarios mapping program 112 determines a ratio for each topological segment to a corresponding geographical segment or segments. For transit maps and maps that change scale for each segment, the corresponding ratio for the topological segments provides a translation between movement within the geographical map to the topological map. In other scenarios where the segments have the same scale, mapping program 112 determines one ratio for all segments of the topological map.

Based on the ratio of a topological segment, mapping program 112 determines a current location of mobile device 110 along the segment. Mapping program 112 retrieves the current location of mobile device 110. Mapping program 112 determines the distance traveled for a given geographical segment (e.g., mobile device 110 is 200 ft along a given geographical segment). Mapping program 112 adjusts the distance traveled along the geographical segment based on the ratio to determine the corresponding distance travelled on the topological map segment (e.g., a ratio of 0.25 pixels/ft. moves the current location on the topological segment by 50 pixels on the display of the image of the topological map). By translating the movement within a geographical map to the topological map, mapping program 112 presents the current location of the user within an image of the topological map. Mapping program 112 continues to update the location within the topological map until mobile device 110 reaches the destination. In scenarios where topological segments have a different ratio to the geographical map, mapping program 112 uses the corresponding ratio when displaying the current position of mobile device 110 on the image of the topological map.

While navigation between a start and destination has been discussed herein, mapping program 112 provides functionality for other scenarios. For example, mapping program 112 receives a topological map. Instead of a user providing a destination and requesting navigation, mapping program 112 maps the user's current location to the image of the topological map as the user, and by consequence mobile device 110, move within the area represented by the topological map. For example, mapping program 112 retrieves a campus map of a college. Mapping program 112 determines the current location of mobile device and associates the current location with a location on the topological map. As the user moves around the campus, mapping program 112 updates the corresponding position on the topological map. This provides the user with an exploration tool, that incorporates the benefits of a topological map (simple, concise and easy to read map) with the accuracy of a geographical map and positioning device 116.

In another scenario, mapping program 112 retrieves a hand-drawn map as a topological map. Typically, hand-drawn maps have a few landmarks or features with names and paths illustrated, but not every detail of the surrounding area is included (e.g., a topological map). Also, the scale of a hand-drawn map may vary even for different portions of the hand-drawn map, much like a transit map for a subway. Furthermore, in this scenario, the hand-drawn map includes markings indicating a route to take from a starting location and to reach a destination. Mapping program 112 performs OCR to determine the names of the features indicated on the hand-drawn map. Mapping program 112 locates and maps the features to locations in a geographical map, as discussed herein. Mapping program 112 performs pattern recognition to determine the relationship or paths between each feature. Mapping program 112 also determines that markings on the hand-drawn map indicate a route to take. Mapping program 112 maps the route indicated to in the map (e.g., a topological route) to paths or roads in a geographical map (e.g., a geographic route). Once the hand-drawn map is retrieved and processed, mapping program 112 retrieves the current location of mobile device 110 and displays the corresponding location on an image of the hand-drawn topological map. Since the features and relationships of the hand-drawn map have been mapped to a geographical map, mapping program 112 provides information such as distance left until destination is reached and estimated time of arrival. As discussed herein, as user of mobile device 110 navigates to the destination, mapping program 112 updates the current geographical position and displays the corresponding topological position on the hand-drawn map.

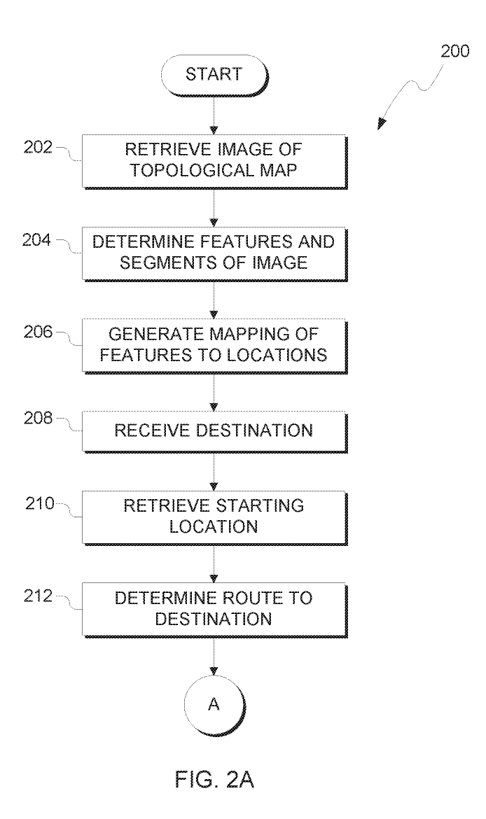

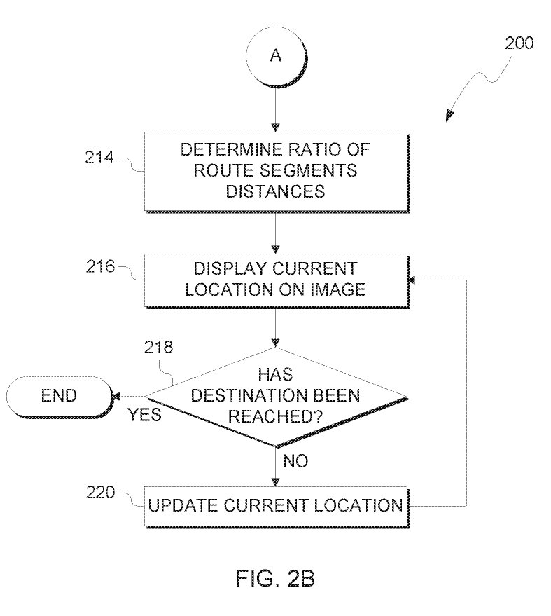

FIGS. 2A-2B illustrates operational processes, generally designated 200, of mapping program 112. In process 202, mapping program 112 retrieves an image of a topological map. In some embodiments, mapping program 112 retrieves an image from capture device 114 of mobile device 110. For example, a user takes a picture of a transit map at a bus station. In other embodiments, mapping program 112 retrieves an image of a topological map from another device (not shown). For example, a user provides a link to mapping program 112 to a location of the image stored on a server. In process 204, mapping program 112 determines the features and segments of image. Mapping program 112 performs OCR to determine the names of features contained in the image, such as landmarks, building, transit stations, and the like. Mapping program 112 performs pattern recognition to determine the location and relationship of the various features. For example, mapping program 112 determines the location of intersections of each line in a map and determines the name of the intersection via OCR. For a subway map, such a process would result in the location, names and connections (e.g., segments connected to) of each subway station.

In process 206, mapping program 112 determines a mapping of each feature in the topological map to a location in a geographical map. Mapping program 112 searches map data 117 for locations matching the text found in the topological map. For features of a topological map that match a location in the geographical map, mapping program 112 generates a mapping of the feature to the location. In scenarios where a match could not be found, mapping program 112 uses contextual information of other features to determine the location of the feature. For example, a feature corresponding to a destination could not be located by mapping program 112. However, a similar location is found in map data 117 (e.g., Riverside Apartments is a location in map data 117 but the destination in the topological map indicates just “Riverside”). As such, mapping program 117 maps the similar feature and location.

In process 208, mapping program 112 receives a destination from a user. In some embodiments, mapping program 112 displays the image of the topological map. Mobile device 110 includes a touch display and a user interacts with the display be touching a destination of the displayed topological map. In other embodiments, mapping program 112 receives an instruction or other information indicating the destination. For example, a user provides an address of a location. If the destination is not a feature of the topological map (e.g., a house address a few blocks away from a subway station), then mapping program 112 selects the nearest feature of the topological map as the destination. Furthermore, mapping program 112 may provide additional navigation using map data 117 (e.g., a geographic map) to reach the penultimate destination (e.g., the originally received address).

In process 210, mapping program 112 retrieves the starting location of mobile device 110. In some embodiments, mapping program 112 retrieves the current location from positioning device 116, setting the starting location for navigation as the current location. In scenarios where positioning device 116 is unable to provide a location, mapping program 112 determines if a feature of the topological map indicates a current location (e.g., a map legend indicates a symbol for “You are here”). If such a feature is present in the topological map, then mapping program 112 associates the starting location with the location of the feature in the topological map. In another scenario, mapping program 112 prompts the user for a starting location (e.g., via a touch enabled display, instruction or other information indicating a location).

In process 212, mapping program 112 determines a route to the destination for both the topological and geographical maps. Mapping program 112 uses the route on the geographical map track the distance and position of mobile device 110 as a user navigates to the destination. Mapping program 112 uses the route on the topological map to provide a interface to display the user's current position and suggested route using the simplicity or additional information provided by the topological map. Additionally, the route on the topological map determines the ratio that movement on a geographical map corresponds to a distance on the topological map. Some topological maps vary in scale not only as a whole, like most maps, but for portions of the map. Two segments or paths of the same size in a topological map may differ in the real-world distance traveled when taking each segment of a route. In some embodiments, mapping program 112 determines a route based on map data 117. For example, mapping program 112 determines a route based the total distance traveled by the route. Since some topological maps vary in scale throughout, what appears as a short distance on a topological map, may not actually be the shortest path. In other embodiments, mapping program 112 determines a route based on map data 117 and other information. For example, mapping program 112 selects a route based on shortest travel time. Mapping program 112 retrieves information regarding travel speed (e.g., average subway train speed per segment) and delay times (e.g., subway traffic information) to determine the total travel time for different possible routes, selecting the route with the shortest travel time.

In process 214, mapping program 112 determines a ratio for each corresponding route segment of the topological route and geographical route. A route segment is a portion of a route between two points on a map. Mapping program 112 determines a distance for each corresponding topological route segment and geographical route segment. Regarding the distance of a topological route segment, mapping program 112 determines the length of a segment based on a distance measurement of the path as displayed in the image of the topological map. For example, mapping program 112 determines the number of pixels a corresponding to the length of a topological segment. Regarding the distance of a geographic route segment, mapping program 112 determines a distance traveled if the segment was taken in a route (e.g., the segment is two miles long).

In some scenarios, a geographical route segment may comprise multiple paths or roads. For example, a single bus route between two bus stops in a topological map may include more than one road to reach the next bus stop. In such a scenario, mapping program 112 combines the distances for each path or road taken in the geographical map to follow the path indicated in the topological map. As such, each topological route segment corresponds to one or more geographical route segments (e.g., a given topological segment has two end points, however a corresponding geographical route may have more than one segment to reach the corresponding end points). In some scenarios, mapping program 112 retrieves geographical route data from a server. For example, a bus company provides the roads that a buys travels between bus stops (i.e., features of a topological map of bus routes). In other scenarios, mapping program 112 determines a path based on map data 117. For example, mapping program 112 determines the shortest path between the locations of the topological features.

Based on the ratio between distance traveled in a geographic map for a segment and the ratio for the segment, mapping program 112 determines the current location on the image of the topological map. Mapping program 112 determines the current location of mobile device 110 on the geographic map based on a retrieved current location from positioning device 116. Mapping program 112 determines how far along the geographic route segment the current position of mobile device 110 is located. For example, a geographic route segment is 500 ft long and the user is currently 100 ft from the start of the segment. The corresponding distance of the topological route segment, is thirty pixels long. Therefore, the ratio between the geographical map and the image of the topological map is 0.06 pixels per ft. (30 pixels/500 ft). A distance of 100 ft from an end point is equal to six pixels. As such mapping program 112 displays the current location of the image of the topological map six pixels from the feature associated with the end point of the segment. Mapping program 112 displays the current location of mobile device 110 on the image of the topological map (process 216), until the destination is reached. If the destination is reached (YES branch of process 218), then mapping program 112 ends processing and waits for a new destination. If the destination has not been reached (NO branch of process 218), mapping program 112 updates the current position of mobile device (process 220). If the current geographic location from positioning device indicates that mobile device is still on the same segment, then mapping program 112 updates the display of the current location on the topological image using the same ratio. If the current location becomes associated with a different section, mapping program 112 uses the ratio between real-world movement to movement within the topological map image for the different section as determined in process 214. As such, as a user navigates the area represented by the topological map, the user's current location is reflected on the topological map.

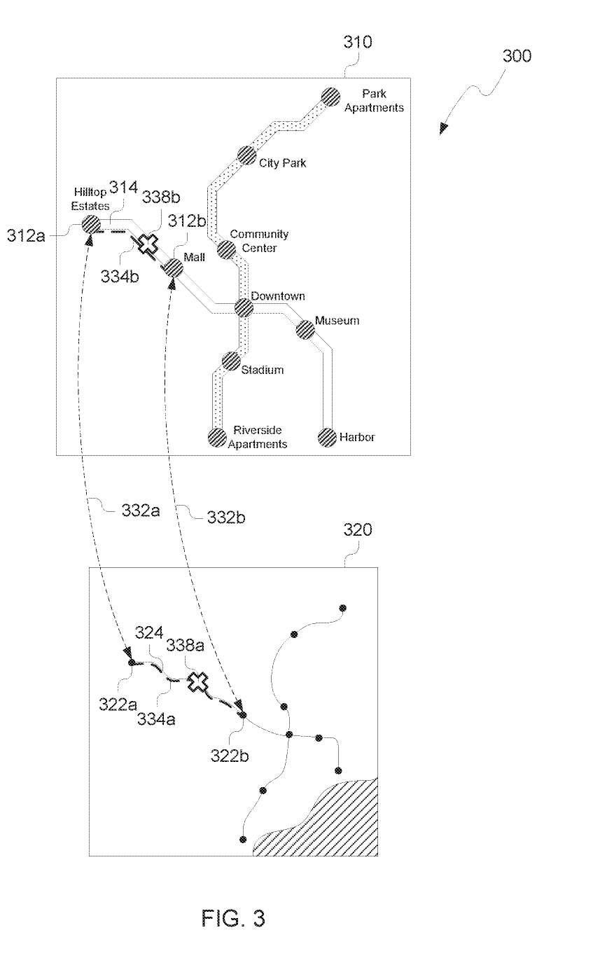

FIG. 3 depicts example visualization, 300, of the feature mapping processes of mapping program 112. Visualization includes topological map 310 and geographical map 320. Topological map 310 includes features 312a-b and topological segment 314. Geographical map 320 includes locations 322a-b and geographical segment 324. Mapping program 112 determines feature mappings 332a-b, segment distances 334a-b, and current locations 338a-b. As discussed herein, mapping program 112 retrieves an image of topological map 310. Mapping program 112 identifies each feature (e.g., 312a) of topological map 310. For example, mapping program 112 performs OCR to determine the text of labels for the features of topological map 310. Furthermore, mapping program identifies and connections between features to determine segments of topological map 310 (e.g., segment 314).

Mapping program 112 determines the location of each feature (e.g., feature 312a) in topological map 310. Mapping program 112 maps each feature to the determined location (e.g., mapping program 112 maps feature 312a to location 322a), generating a respective mapping (e.g., mapping 332a). Mapping program 112 determines a corresponding geographic route segment (e.g., geographic route segment 324) to a topologic route segment (e.g., topological route segment 314). Mapping program 112 determines a distance for each route segment (e.g., geographic route segment 324 is assigned geographic segment distance 334a and topological route segment 314 is assigned topological segment distance 334b). Each segment is associated with two end point (e.g., features 312a-b are associated with topological route segment 314 and locations 322a-b geographic route segment 324).

Mapping program 112 retrieves a current location of mobile device 110. Mapping program 112 determines the location on geographic map 320 based on the current location of mobile device 110 (e.g., current location 338a). Mapping program 112 determines the distance from one of the end points (e.g., locations 322b) in geographic map 320. Furthermore, mapping program 112 determines a ratio between the distance for each segment (e.g., the ratio between geographic segment distance 334a and topological segment distance 334b). Based on the distance from the end point and the ratio, mapping program determines current location 338b on topological map 310. As the current location moves from an end point of a segment, mapping program 112 updates current location 338b for topological map 310. If a differ segment is currently being traveled, mapping program 112 determines a new ratio and distance from an location end point from the segment in geographical map. As a result, mapping program 112 updates the current location 338b on the topological map to match the correct segment and proportional distance from the feature end point.

FIG. 4 depicts a block diagram, 400, of components of mobile device 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Mobile device 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Mapping program 112, image data 115 and map data 117 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 120. In these examples, communications unit 410 includes one or more network interface cards. Communications unit 410 may provide communications through the use of either or both physical and wireless communications links. Mapping program 112, image data 115 and map data 117 may be downloaded to persistent storage 408 through communications unit 410.

I/O interface(s) 412 allows for input and output of data with other devices that may be connected to mobile device 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., Mapping program 112, image data 115 and map data 117, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method comprising:
receiving, by one or more processors, an image of a topological map, wherein the image of the topological map includes at least one of the following: (i) a transit map; (ii) a campus map; or (iii) a park map;
determining, by the one or more processors, a first feature of the topological map, wherein the first feature is indicative of a first geographical location in a geographical map;
determining, by the one or more processors, a second feature of the topological map, wherein the second feature is indicative of a second geographical location in the geographical map;
determining, by the one or more processors, a first topological distance between the first feature and the second feature based, at least in part, on a first amount of pixels between a position of the first feature and a position of the second feature within the image of the topological map;
determining, by the one or more processors, a first geographical distance between the first geographical location and the second geographical location based, at least in part, on the geographical map;
determining, by the one or more processors, a third feature of the topological map, wherein the third feature is indicative of a third geographical location in the geographical map;
determining, by the one or more processors, a fourth feature of the topological map, wherein the fourth feature is indicative of a fourth geographical location in the geographical map;
determining, by the one or more processors, a second topological distance between the third feature and the fourth feature based, at least in part, on a second amount of pixels between a position of the third feature and a position of the fourth feature within the image of the topological map;
determining, by the one or more processors, a second geographical distance between the third geographical location and the fourth geographical location based, at least in part, on the geographical map;
retrieving, by the one or more processors, a current geographical location of a mobile device;
determining, by the one or more processors, a first ratio between the first topological distance and the first geographical distance;
determining, by the one or more processors, a second ratio between the second topological distance and the second geographical distance, wherein the first ratio does not equal the second ratio;
in response to the current geographical location being associated with a first segment of the topological map, determining, by the one or more processors, a first topological location of the mobile device on the image of the topological map, wherein the first topological location is based, at least in part, on the first ratio and the current geographical location of the mobile device;
in response to the current geographical location being associated with a second segment of the topological map, determining, by the one or more processors, a second topological location of the mobile device on the image of the topological map, wherein the second topological location is based, at least in part, on the second ratio and the current geographical location of the mobile device;
displaying, by the one or more processors, the image of the topological map on the mobile device;
receiving, by the one or more processors, input indicative of a destination on the topological map from a user of the mobile device;
determining, by the one or more processors, a route on the topological map based on the current geographical location of the mobile device and the destination on the topological map received from the user of the mobile device; and
displaying, by the one or more processors, the route on the topological map.
